(19) United States
(12) Patent Application Publication
(10) Pub. No.: US 2010/0029811 A1
(43) Pub. Date: Feb. 4, 2010

(54) RUBBER COMPOSITION AND A SEALING MEMBER USING THEREOF

(75) Inventor: Toshikazu SHIROSE, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignees: FUJIKURA RUBBER LTD., Tokyo (JP); HAMAI INDUSTRIES LTD., Tokyo (JP)

(21) Appl. No.: 12/508,997

(22) Filed: Jul. 24, 2009

(30) Foreign Application Priority Data
Jul. 29, 2008 (JP) 2008-195159

(51) Int. Cl. C08K 3/04; C08K 5/11

(52) U.S. Cl. 524/59; 524/565; 524/579; 524/314; 524/310; 524/109

(57) ABSTRACT

A rubber composition comprising a flexible rubber which includes a rubber component and softener, and at least two kinds of carbon blacks having different particle sizes from each other. And a sealing member including a rubber composition comprising a flexible rubber which includes a rubber component and a softener, and at least two kinds of carbon blacks having different particle sizes from each other.

### BACKGROUND OF THE INVENTION

1. Field of the Invention

The present invention relates to rubber composition and sealing member using thereof.

2. Description of the Related Art

Gasoline direct injection is known as one of the engines used for cars. The gasoline direct injection is one of the gasoline engines that inject gasoline as fuel directly and burn it in the cylinder under the high pressure. The gasoline direct injection has less emittance of exhaust fumes and is fuel-efficient. Therefore, the gasoline direct injection meets the requirement to reduction in fuel exhaust emission or improvement of fuel efficiency.

In this gasoline direct injection, as described above, fuel is directly injected in the cylinder under the high pressure. Accordingly, fuel injecting pump used for the gasoline direct injection requires enough resistance properties to high pressure. In addition, the sealing member used for the pump plunger incorporated in the gasoline direct injection also requires enough resistance properties to high pressure.

In addition, for example, to use cars in a cold temperature such as approximately −40 degrees Celsius, the sealing member which is used for pump plunger and incorporated in the gasoline direct injection also requires enough resistance properties to low temperature.

For such sealing members, elastomeric materials are more commonly used rather than metallic materials in view of the possibility of design. As such elastomeric materials, for example, the materials such as Hydrogenated Nitrile Butadiene Rubber (HNBR) or ethylene-propylene-diene rubber (EPDM) are commonly used.

For example, Japanese patent application publication No. Tokkai Hei 10-182882 discloses a sealing member that uses materials in which silicon dioxide is added to Hydrogenated Nitrile Butadiene Rubber (HNBR). However as far as the sealing member disclosed in the publication above, the resistance properties to high pressure and the resistance properties to low temperature remain insufficient in performance, and therefore further development is desired.

### SUMMARY OF THE INVENTION

A purpose of this invention is to provide a sealing member having superior resistance to high pressure and superior resistance to low temperature, as well as a rubber composition having superior resistance to high pressure and low temperature which can be used for the manufacture of such a sealing member.

To accomplish the purpose described above, the first aspect of the present invention is a rubber composition comprising:

a flexible rubber which includes a rubber component and a softener, and

at least two kinds of carbon blacks having different particle sizes from each other.

In addition, to accomplish the purpose described above, the second aspect of the present invention is a sealing member including a rubber composition comprising:

a flexible rubber which includes a rubber component and a softener, and

at least two kinds of carbon blacks having different particle sizes from each other.

According to the present invention, a sealing member having superior resistance to high pressure and superior resistance to low temperature and a rubber composition having superior resistance to high pressure and resistance to low temperature and can be used for the manufacture of such a sealing member are provided.

### BRIEF DESCRIPTION OF THE DRAWINGS

FIG. 1 is a diagram showing to explain the structure wherein two kinds of carbon blacks having different particle sizes from each other exist together in a rubber composition of the first aspect of the present invention.

FIG. 2 is a diagram to explain a sealing member which is used for pump plunger in one embodiment of the second aspect of the present invention.

### DETAILED DESCRIPTION OF THE PREFERRED EMBODIMENTS

A rubber composition and sealing member according to the present invention will be explained below in detail.

### Embodiment

### Rubber Composition

The rubber composition of the first aspect of the present invention comprises: a flexible rubber and at least two kinds of carbon blacks having different particle sizes from each other. Other suitable components can be included in the rubber composition if necessary.

### (Flexible Rubber)

The flexible rubber is a rubber whose flexibility is enhanced by mixing a softener into the rubber component.

### <Softener>

In this specification, softener means an agent that is mixed into the rubber component to enhance its flexibility and reduce its hardness.

As for the suitable softener, examples include but are not limited to: petroleum softener, phthalate ester plasticizer, aliphatic ester plasticizer, aliphatic diacid base ester plasticizer, phosphate ester plasticizer, citrate ester plasticizer, trimellitate plasticizer, epoxidized vegetable oil, vegetable oil-derived softener, polyetherester and polybutene. It is possible to use just one type of softener or to combine two or more types.

When the petroleum softener is used as the softener, the flexible rubber is an oil-extended rubber. As for the petroleum softener, suitable examples includes but are not limited to: paraffinic process oil, naphthenic process oil, aromatic process oil, white oil, petrolatum, gilsonite and mixtures thereof.

The Viscosity Gravity Constant of the petroleum softener (V. G. C. value) is not limited to any specific value. For example, paraffinic process oil whose Viscosity Gravity Constant is within the range from 0.900 to 1.049, naphthenic process oil whose Viscosity Gravity Constant is within the range from 0.850 to 0.899 or the like can be preferably used.

The oil-extended rubber is a rubber in which an oil component and a rubber component are homogeneously mixed. The molecular momentum of the oil component is relatively greater than that of the rubber component. Therefore, it is inferable that the flexibility of the rubber molecules in the rubber component at low temperature (that is, how freely the rubber molecules can move in low temperature region) can be improved and the resistance properties to low temperature can be enhanced by mixing the oil component into the rubber component.

Similarly, the resistance properties of the rubber composition to low temperature can be enhanced for the same reasons of that of the oil-extended rubbers by including a plasticizer in the rubber component.

When phthalate ester plasticizer is used as the softener, as for the suitable phthalate ester plasticizer, examples include but are not limited to: dimethyl phthalate (DMP), diethyl phthalate (DEP), dibutyl phthalate (DBP), diheptyl phthalate (DHP), di-2-ethylhexyl phthalate (DEHP), di-n-octyl phthalate (DonP), diisodecyl phthalate (DIDP), butyl benzyl phthalate (BBP), diisononyl phthalate (DINP) and the like. It is possible to use just one type of plasticizer or to combine two or more types.

The examples of the adipate ester plasticizer suitable for using as the softener include but not limited to: dimethyl adipate (DMA), dibutyl adipate (DBA), diisobutyl adipate (DIBA), di-2-ethylhexyl adipate (DOA), diisononyl adipate (DINA), bis(butyl diglycol) adipate (BXA-R), diisodecyl adipate (DIDA), di-2-ethyl hexyl azelate (DOZ) and the like. It is possible to use just one type of plasticizer or to combine two or more types.

The examples of the aliphatic diacid base ester plasticizer suitable for using as the softener include but not limited to: dimethyl sebacate (DMS), dibutyl sebacate (DBS), dioctyl sebacate (DOS) and the like.

It is possible to use just one type of plasticizer or to combine two or more types.

The examples of the phosphate ester plasticizer suitable for using as the softener include but not limited to: aryl phosphate [for example, triphenyl phosphate (TPP), tricresyl phosphate (TCP), trixyl phosphate and Diphenylcresyl phosphate], alkyl phosphate [for example, trimethyl phosphate (TMP), triethyl phosphate (TEP), tributhyl phosphate (TBP), tri-2-ethylhexyl phosphate (TEP), trioctyl phosphate, trilauryl phosphate and triisodecyl phosphate], alkyl aryl phosphate [for example, phenyl dietyl phosphate, phenyl dibutyl phosphate, phenyldioctyl phosphate, diphenylethyl phosphate, diphenylbutyl phosphate and diphenyloctyl phosphate]. It is possible to use just one type of plasticizer or to combine two or more types.

The example of the citrate ester plasticizer suitable for using as the softener includes but not limited to: acetyl tributylate (ATBC) or the like.

The examples of the trimellitate plasticizer suitable for using as the softener include but not limited to: tri (n-octyl,n-decyl) trimellitate, tri (2-ethylhexyl) trimellitate or the like.

The examples of the epoxidized vegetable oil suitable for using as the softener include but not limited to: epoxidized soy oil, epoxidized ricinus, epoxidized flaxseed oil, epoxidized safflower oil or the like.

The examples of the vegetable-oil-based softener suitable for using as the softener include but not limited to: ricinus, cotton oil, canola oil, oil of palm, copra oil, rosin oil and the like.

In addition, polyether ester, polybutene or the like can be used.

### <Rubber Component>

As for the suitable rubber component, examples include but not limited to: ethylene-propylene-diene rubber (EPDM), acrylonitrile butadiene rubber (NBR), hydrogenated nitrile butadiene rubber (HNBR) and the mixtures thereof.

For example, oil-extended EPDM, in which EPDM is used as the rubber component and paraffinic process oil is used as the softener, can be used preferably as the flexible rubber. This is because the affinity of EPDM for paraffinic process oil is high.

When oil-extended EPDM is used as the rubber component, the range of contained amount of ethylene is preferably from 40 to 70% by weight, more preferably from 40 to 60% by weight, most preferably from 49 to 55% by weight, per the total weight of the oil-extended EPDM component.

When the contained amount of ethylene is more than 70% by weight, the stretch properties of the rubber component tend to be low and the processability of the seal member in molding processes tends to be insufficient.

On the other hand, when the contained amount of ethylene is less than 40% by weight, the advantageous effect from the improvement of the creep rupture strength etc. tends to be small and the strength of the resulting sealing member or the like may be insufficient even if the sealing member is easily formed in processing.

In addition, not only oil-extended EPDM, but also oil-extended NBR or oil-extended HNBR containing petroleum softener, can be used as the flexible rubber.

In addition, for example, it is also preferable to use NBR as the rubber component and to use adipate ester plasticizer, vegetable oil-derived softener, polyetherester or the like as the softener. It is because the affinity of NBR for adipate ester plasticizer, vegetable oil-derived softener, polyetherester or the like is high. In this case, the adipate ester plasticizer, vegetable oil-derived softener or polyetherester which can be used is not limited to any specific one type and all the examples described above can be preferably used.

With respect to the flexible rubber, the preferable content of the softener per 100 pts.wt. of the rubber component is from 20 pts.wt %. to 70 pts.wt %. The more preferable content of it is from 30 pts.wt. % to 50 pts.wt. %

When the content is less than 20 pts.wt. %, preferable resistance to low temperature of the rubber composition might not be obtained, while the content is more than 70 pts.wt. %, the working efficiency of kneading might be down by the excess softener component.

### (Carbon Blacks)

In the present invention, the carbon blacks contained in the rubber compositon are “at least two kinds of carbon blacks having different particle sizes from each other”

### <Kinds of Carbon Blacks>

In the specification, the “kind” of carbon blacks means each grade of carbon blacks classified like ISAF (Intermediate Super Abrasion Furnace Black) grade, MAF (Medium Abrasion Furnace Black) grade, SAF (Super Abrasion Furnace Black) grade, SRF (Semi-Reinforcing Furnace Black) grade, GPF (General Purpose Furnace Black) grade, FT (Fine Thermal Furnace Black) grade, MT (Medium Thermal Furnace Black) grade, HAF (High Abrasion Furnace Black) grade, FEF (Fast Extruding Furnace Black) grade or the like. (See Gomu Kogyo Binran (Rubber Industry Handbook) edited by Nihon gomu kyokai, publish date: Jun. 15, 1993).

Therefore, for example, the ISAF grade and the MAF grade can be preferably combined as the two kinds of carbon blacks.

### <Particle Size of the Carbon Blacks>

The “particle size” of the carbon blacks means an average particle size of the same kind of carbon blacks (that is, an average particle size measured according to JIS K-6221 (1982), “Testing Methods of Carbon Black for Rubber Industry”).

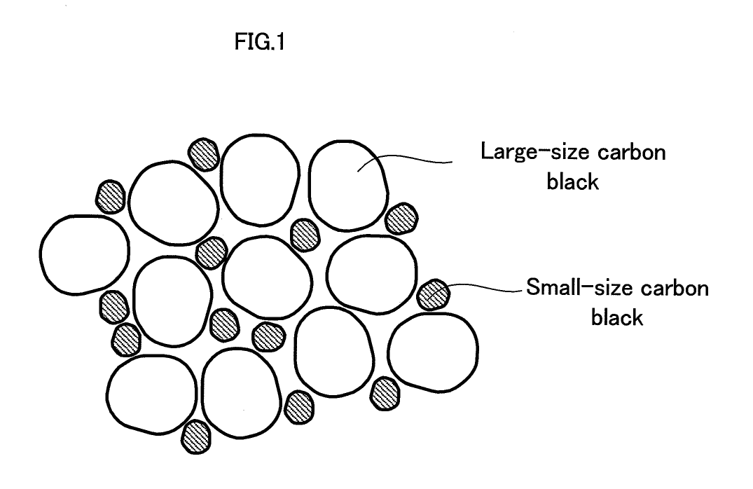

In the present invention, the resistance to high pressure of rubber composition as a whole is improved by means of use at least two kinds of carbon blacks having different particle sizes from each other. To be more precise, in the present invention of rubber composition, as is shown in FIG. 1 conceptually, at least two kinds of carbon blacks, comprising a carbon black having a large average particle size (hereinafter, “large-size carbon black”) and a carbon black having a small average particle size (hereinafter, “small-size carbon black”) are included. The “large-size carbon black” acts to improve the rigidity of the rubber composition, while the “small-size carbon black” acts to fill the gaps among the “large-size carbon black” particles. By acting as described above, the resistance to high pressure of the rubber composition was improved.

In the carbon blacks having at least two kinds and different particle sizes from each other, the difference value of the average particle between the “large-size carbon blacks” and the “small-size carbon blacks” (that is, the average particle size of the “large-size carbon blacks”−the average particle size of the “small-size carbon blacks”), is not limited to any one specific number, but is preferably from 7 nm to 100 nm and is more preferably from 15 nm to 80 nm.

When the difference value of the average particle is less than 7 nm or more than 100 nm, the objects of the present invention, namely, superior resistance to high pressure and to low temperature, may not be obtained effectively.

Below are listed some examples of the average particle size of the above carbon blacks by kind. The average particle size value of the carbon blacks may differ according to each manufacturer. The standard value of the average particle size is, for example, approximately 23 nm when the kind of carbon black is ISAF grade, approximately 38 nm when the kind of carbon black is MAF grade, approximately 19 nm when the kind of carbon black is SAF, approximately 66 nm when the kind of carbon black is SRF, approximately 62 nm when the kind of carbon black is GPR, approximately 122 nm when the kind of carbon black is FT, approximately from 450 nm to 556 nm when the kind of carbon black is MT, approximately 28 nm when the kind of carbon black is HAF, approximately 43 nm when the kind of carbon black is FEF (in conformity with JIS K-6221-1982).

### <Contained Amount of the Carbon Blacks>

The preferable contained amount of the carbon blacks is such as, but not limited to the amount value from 70 pts.wt. to 150 pts.wt. per 100 pts.wt. of the flexible rubber.

When the contained amount is less than 70 pts.wt., the desired improvement of resistance to high pressure of the rubber composition may not be obtained. On the other hand, when the contained amount is more than 150 pts.wt., the rigidity of the rubber composition may too high.

The contained amount of the carbon blacks means the contained amount percentage of all kinds of carbon blacks included in the rubber composition.

The case where carbon black of ISAF grade and the carbon black of MAF grade are combined and included in the rubber composition is taken for one example. In this case, the contained amount of the carbon blacks means the value of sum of the contained amount percent of the ISAF grade carbon black and the MAF grade carbon black. It is preferable that this value is within the range from 70 pts.wt. to 150. pts.wt. per 100 pts.wt. of the flexible rubber.

In addition, the ratio by weight of “small-size carbon blacks” and “large-size carbon blacks” is not limited to any specific number, but the range from 0.01 to 1 is preferred, the range from 0.05 to 0.4 is more preferred, the range from 0.1 to 0.35 is further preferred on the basis of (“small-size carbon blacks”)/(“large-size carbon blacks”).

When the ratio is less than 0.01, since the contained amount of the “small-size carbon blacks” is low, the gaps among the “large-size carbon blacks” may not be filled up enough. On the other hand, when the ratio is more than 1, the rigidity of the rubber composition may not be high enough.

Needless to say, the present invention of the rubber composition includes the case where more than three kinds of carbon blacks are included.

In this case, the difference value of the average particle and the ratio by weight are the values which are obtained when the value of the largest size carbon blacks included in the rubber composition is used as the value of the “large-size carbon blacks” and the value of the smallest size carbon blacks is used as the value of the “small-size carbon blacks”.

### (Other Components)

The other suitable components which can be included in the present rubber composition are such as, but not limited to: cross-linking agent (a vulcanizing agent), co-cross-linking agent, rust retardant, vulcanizing accelerator, vulcanizing retardant or the like. In addition, fillers other than carbon blacks can be included.

As the cross-linking agent, such as, but not limited to: di-cumyl peroxide, sulfur, sulfur dichloride, morpholine disulfide, dithio-di-caprolactam, m-phenylene dimaleimide or the like can be used.

As the cross-linking agent, alkyl peroxide or alicyclic peroxide can be mixed. For example, as for the alkyl peroxide or alicyclic peroxide, such as, but not limited to: 3,3,5-trimethyl hexanon peroxide, diisobutyl peroxide, 1,1-di(t-butyl peroxy)3,3,5-trimethyl cyclohexane, 2,5-dimethyl-2,5-di(t-butyl peroxy)hexan, 2,5-dimethyl-2,5-di(t-buthyl peroxy)hexan, 2,5-dimethyl 2,5-di(t-buthyl peroxy)hexan, 2,5-dimethyl-2,5-di(t-buthyl peroxy)hexan-3, n-buthyl-4,4-bis(t-buthyl peroxy), valerate, di-sec-buthyl peroxy dicarbonate etc. or the like can be used. It is possible to use just one type of agent or to combine two or more types.

The contained amount of the cross-linking agent is not limited to any specific number, but the amount value from 1 pts. wt. to 12 pts. wt. per 100 pts.wt. of the flexible rubber is preferable. When the contained amount of the cross-linking agent is less than 1 pts.wt, it may take extra time to cross-link the rubber and that cause the decrease of the yield. On the other hand, the contained amount of the cross-linking agent is more than 12 pts. wt., unexpected side reaction may occur.

A co-cross-linking agent is an agent which cross-links by itself. In addition, the co-cross-linking agent reacts and cross-links with rubber component and acts to make polymerized material composition with a high degree of polymerization. By including the co-cross-linking agent, the resistance to oil, the mechanical strength, the compression set of the rubber composition or the like can be improved.

As the co-cross-linking agent, such as, but not limited to: ethylene glycol dimethacrylate (EDMA), trimethyl-propane trimethacrylate (TPTA), trimethylol propane trimethacrylate, triallyl cyanurate (TAC), triallyl iso cyanurate (TAIC), triallyl trimelitate (TAM), tetra allyl terephtalamide or the mixtures of these can be used.

The contained amount of the co-cross-linking agent is not limited to any specific number, but from 1 pts.wt. to 10 pts.wt. per 100 pts.wt. of the flexible rubber is preferable. When the amount of the co-cross-linking agent is less than 1 pts. wt., the progression rate of the cross-link may insufficient and as a result, the durability may be insufficient even if the sealing member is easily formed in processing. On the other hand, when the amount of the cross-linking agent is more than 10 pts.wt., there is a possibility that the breaking elongation of the rubber composition decrease and as a result, the durability may be insufficient even if the sealing member is easily formed in processing.

As the rust retardant, for example, 2,2,4-trimethyl-1,2-dihydroquinoline polymer, dioctyldiphenylamine, N,N′-diphenyl-p-phenylenediamine or the like can be used.

As the vulcanizing accelerator, for example, composition containing thiuram, thiazole, sulphenamide, thiourea or the like can be used.

As the vulcanizing retardant, for example, salicylic acid can be used. As the fillers other than carbon blacks, for example, white filler (silica), zinc oxide (zinc flower), alumina, talc, oxidized titanium, clay, magnesium carbonate, calcium carbonate (HAKUENKA), calcium oxide or the like can be used.

In addition, as the oil-extended EPDM, the commercially available products in which oil component is originally contained can be used. One the other hand, for example, oil-extended NBR or oil-extended HNBR can be produced by adding oil component to solid rubber component in kneading machine.

When kneading oil component by using the kneading machine, it is preferable to knead only rubber component first before kneading oil component. It is because the rubber is easy to slip in the kneading machine if the oil component and the rubber component are put in at the same time.

The aforementioned rubber composition of the first aspect of the invention has superior resistance to high pressure and the resistance to low temperature. Therefore, the rubber composition can be used for the sealing member of the second aspect of the invention.

### [Sealing Member]

The sealing member of the second aspect of the present invention comprises: a rubber composition comprising a flexible rubber which includes a rubber component and a softener, and at least two kinds of carbon blacks having different particle sizes from each other.

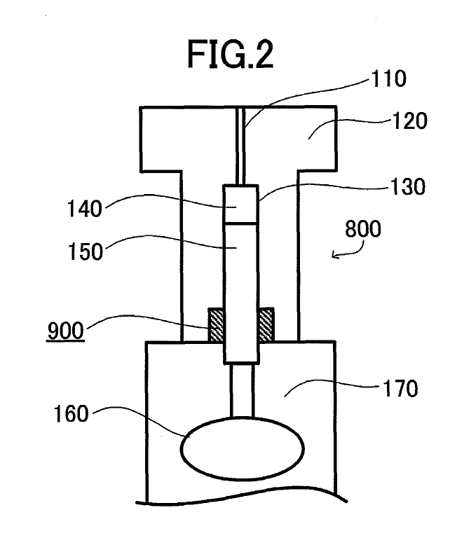

The sealing member can be used for various purposes. For example the sealing member can be used as the sealing of pump plunger 150 used in fuel injecting pumps 800 of gasoline direct injection as shown in the embodiment of FIG. 2

In FIG. 2, fuel injecting pumps 800 includes pump housing 120 in which pump cylinder 130 is formed. Inside the pump housing 120, delivery line 110 is formed. The upper edge of delivery line 110 is connected to unshown reserve tank.

Pump plunger 150 is axially movable within pump cylinder 130. A high pressure room 140 is formed in upper part of pump plunger 150. Pump plunger 150 moves up and down in pump cylinder 130 by means of cum conducting member 160.

Sealing member 900 is arranged between the inner periphery of the apical end of pump cylinder 130 and the outer periphery of near-apical end of pump plunger 150. In other word, at near-bottom head of pump plunger 150, groove into which circular sealing member is fitted is formed. And into the groove, circular sealing member 900 is fitted. Sealing member 900 seals between pump cylinder 130 and chamber 170.

Sealing member 900 has resistance to high pressure and the resistance to low temperature, since the rubber composition of the present invention is used as the material Therefore, even if high pressured fuel is injected, the risk that the sealing function between pump cylinder 130 and chamber 170 would be impaired is extremely small. In addition, even if it is used in a cold temperature, the risk of impairing the sealing ability would be extremely low.

In the above described embodiment, sealing member 900 is the sealing member of pump plunger used in fuel injecting pumps. But the sealing member of the present invention is not limited to this type of embodiment. The sealing member of the present invention can be preferably used in various environment where the resistance to high pressure and the resistance to low temperature are required. For example, the sealing member of the present invention can be used as the sealing member of pump plunger that is used in anti lock brake system for controlling the fluid pressure of the car.

### EXAMPLES

Next, some examples of the present invention are explained. The present invention should not be interpreted as limited to the following examples.

[resistance to high pressure·resistance to low temperature]

### Example 1

### Preparation of Rubber Composition

As the oil-extended rubber, an oil-extended EPDM (30% oil-extended by weight on the basis of EPDM) was prepared (the flexible rubber) (100 pts.wt.). The ratio of E monomer/P monomer/ENB monomer of the EPDM was 52/44.5/3.5. To the prepared EPDM, SEAST G 116 (made by TOKAI CARBON CO., LTD: MAF grade, the average particle size: 38 nm) (90 pts.wt.) and SHOW BLACK N220 (made by CABOT JAPAN K. K., ISAF grade, the average particle size 23 nm) (20 pts.wt.) were added as carbon blacks.

Next, Percumyl® D (made by NOF CORPORATION: di-cumyl peroxide) as a vulcanizing agent (6 pts.wt), acryester ED (made by MITSUBISHI RAYON CO., LTD.: Ethylene Glycol Methacrylate (EDMA)) as a co-cross-linking agent (3 pts.wt.), Nocrac 224-s (made by OUCHI SHINKO CHEMICAL INDUSTRIAL.: 2,2,4-trimethyl-1,2-dihydroquinolin polymer) as a rust retardant (1 pts.wt.), ADEKA FATTY ACID SA-400 (made by ADEKA: Stearic acid) as a vulcanizing accelerator (1 pts.wt.) and Zinc Oxide as a filler (5 pts. wt.) were added.

Then, rubber compound which can be cross-linked was prepared by means of kneading the above resultant mixture in open-roll mixers. And then, the first vulcanization was conducted for 10 minutes under 170 degrees Celsius and after that the second vulcanization was conducted for 2 hours under 150 degrees Celsius. Eventually, the rubber composition of the present invention was obtained. The obtained composition was shown in table 1.

### <Tests>

Tension test, Elongation test, hardness test, compression set test, TR test and Gehman twist test were conducted to the sample specimen of the obtained composition.

The tension test and elongation test were carried out in accordance with JIS K6251. The hardness was measured in accordance with Duro A hardness of JIS K6253. The compression set test was carried out in accordance with JIS 6262 and the compression rate was 25%.

The TR test was carried out in accordance with JIS K6261. To be more precise, in the TR test, a certain amount of tension was provided to the frozen sample specimen and then the recovery rate of elongation was measured with continually increasing the temperature.

In the Gehman twist test, over a temperature range from frozen temperature to room temperature, the sample specimen was twisted by twist wire. And based on the twist angle of the sample specimen, the resistance to low temperature was be evaluated.

### <Results>

As the result of the tests, the tension of the sample specimen was 18.1 MPa. The elongation of the sample specimen was 120%. The hardness of the sample specimen was 89. The compression set of the sample specimen was 15%. In addition, as the result of the TR test, TR10 was −50° C., TR30 was −42° C., TR50 was −36° C. and TR70 was −28° C. As the Gehman twist test, T2 was −35° C., T5 was −49° C., T10 was −52° C. and T100 was −63° C. The results were shown in table 2.

### Comparison Example 1

### Preparation of Rubber Composition

A rubber composition was prepared in the same manner as in example 1 with the following exceptions:

(1) A non-oil extended EPDM (The ratio of E monomer/P monomer/ENB monomer of the EPDM was 50/46/4) (100 pts.wt.) was used instead of the oil-extended EPDM (30% oil-extended by weight on the basis of EPDM)
(2) One kind of carbon black, SEAST G 116 (65 pts.wt.) was used instead of the combination of two kinds of carbon blacks, SEAST G 116 (9 pts.wt.) and Show Black N220 (20 pts.wt.))
(3) The amount of the vulcanizing agent was changed from 6 pts.wt. to 2.7 pts.wt.
(4) The amount of the co-cross-linking agent was changed from 3 pts.wt. to 2 pts.wt. The obtained composition was shown in table 1.

### <Tests and Results>

By using the obtained composition as a sample specimen, all kinds of tests were conducted in the same manner as disclosed in <tests> in example 1. As the result, the tension of the sample specimen was 23.5 MPa, the elongation of the sample specimen was 220%, the hardness of the sample specimen was 77 and the compression set of the sample specimen was 15%. As the result of the TR test, TR10 was −45° C., TR30 was −39° C., TR50 was −34° C. and TR70 was −29° C. As the Gehman twist test, T2 was −36° C., T5 was −46° C., T10 was −48° C. and T100 was −55° C. The results were shown in table 2.

### Comparison Example 2

### Preparation of Rubber Composition

A rubber composition was prepared in the same manner as in example 1 with the following exceptions:

(1) One kind of carbon black, Show Black N220 (75 pts.wt.)) was used instead of the combination of two kinds of carbon blacks, SEAST G 116 (9 pts.wt.) and Show Black N220 (20 pts.wt.))
(2) The amount of the vulcanizing agent was changed from 6 pts.wt. to 4 pts.wt.
(3) The amount of the co-cross-linking agent was changed from 3 pts.wt. to 2 pts.wt. The obtained composition is shown in table 1.

### <Tests and Results>

By using the obtained composition as a sample specimen, all kinds of tests were conducted in the same manner as disclosed in <tests> in example 1.

As the result, the tension of the sample specimen was 21.4 MPa, the elongation of the sample specimen was 280%, the hardness of the sample specimen was 80 and the compression set of the sample specimen was 19%. In addition, as the result of the TR test, TR10 was −49° C., TR30 was −39° C., TR50 was −32° C. and TR70 was −23° C. As the result of Gehman twist test, T2 was −29° C., T5 was −45° C., T10 was −50° C. and T100 was −66° C. The results were shown in table 2.

TABLE 1

| | | COMPARISON | COMPARISON |
|---|---|---|---|
| | EXAMPLE | EXAMPLE1 | EXAMPLE2 |
| rubber | oil-extended EPDM: | non oil-extended EPDM: | non oil-extended EPDM: |
| component or | 100 pts. wt. | 100 pts. wt. | 100 pts. wt. |
| oi-extended | | | |
| carbon blacks | SEAST G116(38 nm): | SEAST G116(38 nm): | Show Black N220(23 nm): |
| | 90 pts. wt. | 65 pts. wt. | 75 pts. wt. |
| | Show Black N220(23 nm): | | |
| | 20 pts. wt. | | |
| vulcanizing agent | Percumyl D: 6 pts. wt. | Percumyl D: 27 pts. wt. | Percumyl D: 4 pts. wt. |
| co-cross-linking | Acryester ED: 3 pts. wt. | Acryester ED: 2 pts. wt. | Acryester ED: 2 pts. wt. |
| agent | | | |
| others | Nocrac 224s: 1 pts. wt. | Nocrac 224s: 1 pts. wt. | Nocrac 224s: 1 pts. wt. |
| | Adeka fatty acid SA-300: | Adeka fatty acid SA-300: | Adeka fatty acid SA-300: |
| | 1 pts. wt. | 1 pts. wt. | 1 pts. wt. |
| | Zinc Oxide(second-class): | Zinc Oxide(second-class): | Zinc Oxide(second-class): |
| | 5 pts. wt. | 5 pts. wt. | 5 pts. wt. |

TABLE 2

| | | | COMPARISON | COMPARISON |
|---|---|---|---|---|
| | | EXAMPLE | EXAMPLE1 | EXAMPLE2 |
| tension(Mpa) | | 18.1 | 23.5 | 21.4 |
| elongation(%) | | 120 | 220 | 280 |
| hardness(DuroA) | | 89 | 77 | 80 |
| compression set test(%) | | 15 | 15 | 19 |
| (compression rate 25%) | | | | |
| TR test | TR 10(° C.) | −50 | −45 | −49 |
| | TR 30(° C.) | −42 | −39 | −39 |
| | TR 50(° C.) | −36 | −34 | −32 |
| | TR 70(° C.) | −28 | −29 | −23 |
| Gehman twist test | TR 2(° C.) | −35 | −36 | −29 |
| | TR 5(° C.) | −49 | −46 | −45 |
| | TR10(° C.) | −52 | −48 | −50 |
| | TR100(° C.) | −63 | −55 | −66 |

As described above, the composition obtained in example 1 which includes an oil-extended rubber and two kinds of carbon blacks having different particle sizes from each other was superior in resistance to high pressure having Duro A hardness 89. In addition, with respect to the resistance to low temperature, for example, TR10 was −50° C. and T10 was −52° C. Favorable results were attained.

On the other hand, with respect to the composition obtained in comparison example 1 which includes a non oil-extended rubber and only one kind of carbon black, Duro A hardness was 77 and TR10 was −45° C. and T10 was −48° C. With respect to the resistance to high pressure and the resistance to low temperature, the results were inferior to the results of example 1.

In addition, with respect to the composition obtained in comparison example 2 which includes an oil-extended rubber and only one kind of carbon black, Duro A hardness was 80 and TR10 was −49° C. and T10 was −50° C. With respect to the resistance to high pressure and the resistance to low temperature, the results were inferior to the results of example 1.

According to the results described above, the composition obtained in example 1 which includes an oil-extended rubber and two kinds of carbon blacks having different particle sizes from each other was proved having superior in resistance to high pressure and resistance to low temperature. In like wise, it is predictable that the composition which comprises a flexible rubber which includes a rubber component and softener, and two kinds of carbon blacks having different particle sizes from each other has superior in resistance to high pressure and resistance to low temperature.

### [Preparation of Sealing Member]

By using the rubber composition obtained in example 1, the sealing member which seals between pump cylinder and chamber was prepared shown in FIG. 2. Then, the obtained sealing member was used as fuel injecting pumps shown in FIG. 2. As a result, it was confirmed that this sealing member was superior in sealing property and having excellent resistance to high pressure and the resistance to low temperature.

### Reference Example

### Ratio by Weight of Carbon Blacks

The properties of the rubber composition were tested with varying the ratio by weight of “small-size carbon blacks” and “large-size carbon blacks”.

### Reference Example 1

### Preparation of Rubber Composition

As a rubber component, non-oil-extended hydrogenated nitrile butadiene rubber (HNBR) was prepared (100 pts.wt). To the prepared HNBR, SEAST G 116 (10 pts.wt.) and SHOW BLACK N220 (60 pts.wt.) were added as carbon blacks.

Next, to this obtained mixture, Vul-Cup 40KE (made by Hercules Inc., 1,3-bis (t-butylperoxy isopropyl benzene (organic peroxide)) as a vulcanizing agent (7 pts.wt.) and acrylate TMP (made by Mitsubishi Rayon Company: trimethylol propane trimethacrylate) (3 pts. wt.) as a co-cross-linking agent were added. Then, rubber compound which can be cross-linked was prepared by kneading the above resultant mixture in open-roll mixers. And then, the first vulcanization was conducted for 10 minutes under 170 degrees Celsius and after that the second vulcanization was conducted for 2 hours under 150 degrees Celsius. Eventually, the rubber composition was obtained.

### <Tests and Results>

By using the obtained composition as a sample specimen, all kinds of tests were conducted in the same manner as disclosed in <tests and results> in reference example 1. As the result, the tension of the sample specimen was 27.1 MPa, the elongation of the sample specimen was 250%, the hardness of the sample specimen was 75. The results were shown in table 3.

### Reference Example 2

### Preparation Of Rubber Composition

A rubber composition was prepared in the same manner as in reference example 1 with the following exceptions:

(1) The amount of the carbon black, SEAST G 116 (10 pts.wt.) and Show Black N220 (60 pts.wt.)) were respectively changed to SEAST G 116 (30 pts.wt.) and Show Black N220 (40 pts.wt.)).

### <Test and Results>

By using the obtained composition as a sample specimen, all kinds of tests were conducted in the same manner as disclosed in <tests and results> in reference example 1. As the result, the tension of the sample specimen was 24.0 MPa, the elongation of the sample specimen was 210%, the hardness of the sample specimen was 78. The results were shown in table 3.

### Reference Example 3

### Preparation of Rubber Composition

A rubber composition was prepared in the same manner as in reference example 1 with the following exceptions:

(1) The amounts of the carbon black, SEAST G 116 (10 pts.wt.) and Show Black N220 (60 pts.wt.)) were respectively changed to SEAST G 116 (80 pts.wt.) and Show Black N220 (10 pts.wt.)).

### <Test and Results>

By using the obtained composition as a sample specimen, the tension, the elongation and the hardness were respectively tested. As the result, the tension of the sample specimen was 22.9 MPa, the elongation of the sample specimen was 140%, the hardness of the sample specimen was 85. The results were shown in table 3.

TABLE 3

| | | REFERENCE | REFERENCE | REFERENCE |
|---|---|---|---|---|
| | | EXAMPLE1 | EXAMPLE2 | EXAMPLE3 |
| rubber component | | 100 pts. wt. | 100 pts. wt. | 100 pts. wt. |
| (nonoil-extended | | | | |
| rubber) | | | | |
| carbon | SEAST | 10 pts. wt. | 30 pts. wt. | 80 pts. wt. |
| blacks | G116 | | | |
| | (38 nm) | | | |
| | Show Black | 60 pts. wt. | 40 pts. wt. | 10 pts. wt. |
| | N220 | | | |
| | (23 nm) | | | |

| | | | |
|---|---|---|---|
| cross-linking | 7 pts. wt. | 7 pts. wt. | 7 pts. wt. |
| agent(Vul-Cup 40KE) | | | |
| co-cross-linking | 3 pts. wt. | 3 pts. wt. | 3 pts. wt. |
| agent(AcryesterTMP) | | | |
| tension(Mpa) | 27.1 | 24.0 | 22.9 |
| elongation(%) | 250 | 210 | 140 |
| hardness(DuroA) | 75 | 78 | 85 |

According to the above results, the hardness of the composition of reference example 1 was 75, the hardness of the composition of reference example 2 was 78 and the hardness of the composition of reference example 3 was 85. According to the results, it is inferable that the hardness value of the composition tend to be further increased when the ratio by weight of “small-size carbon blacks”/“large-size carbon blacks” is from 0.01 to 1 compared to the composition having a ratio over 1.

### Reference Example

### Property of High Resistance to Low Temperature

With respect to each an oil-extended rubber and a non oil-extended rubber, TR test was conducted. The obtained results of properties of resistance to low temperature were compared. As the oil-extended rubber, EPDM same as Example 1 was used. As the non oil-extended rubber, three kinds of non oil-extended grade EPDM each were made from different manufacturers were used.

With respect to the oil-extended EPDM, TR 10 was −50° C., TR 30 was −42° C., TR 50 was −36° C. and TR 70 was −28° C.

With respect to the non oil-extended EPDM1, TR 10 was −47° C., TR 30 was −35° C., TR 50 was −27° C. and TR 70 was −18° C. The ratio of E monomer/P monomer/ENB monomer of the non oil-extended EPDM1 was 49/446.5/4.5.

With respect to the non oil-extended EPDM2, TR 10 was −43° C., TR 30 was −33° C., TR 50 was −24° C. and TR 70 was −15° C. The ratio of E monomer/P monomer/ENB monomer of the non oil-extended EPDM2 was 49/41.5/9.5.

With respect to the non oil-extended EPDM3, TR 10 was −42° C., TR 30 was −34° C., TR 50 was −28° C. and TR 70 was −20° C. The ratio of E monomer/P monomer/ENB monomer of the non oil-extended EPDM3 was 50/46/4.

The results were shown in table 4.

TABLE 4

| | | oil-extended rubber | | | |
|---|---|---|---|---|---|
| | | oil- | non oil- | non oil- | non oil- |
| | | extended | extended | extended | extended |
| rubber component | | EPDM | EPDM 1 | EPDM 2 | EPDM 3 |
| TR test | TR10(° C.) | −50 | −47 | −43 | −42 |
| | TR30(° C.) | −42 | −35 | −33 | −34 |
| | TR50(° C.) | −36 | −27 | −24 | −28 |
| | TR70(° C.) | −28 | −18 | −15 | −20 |

For example, TR10 of oil-extended EPDM was −50° C. while TR10 of non oil-extended was −47° C., TR10 of non oil-extended EPDM2 was −43° C. and TR10 of non oil-extended EPDM3 was −42° C.

The results show that it is inferable that the composition in which an oil-extended rubber is used is superior in resistance to low temperature to the composition in which a non oil-extended rubber is used. It is considered that the results are arising from the enhanced flexibility by means of adding the rubber molecule in the rubber component described above.

As described above, the composition which comprises a flexible rubber (for example, oil-extended rubber) and at least two kinds of carbon blacks having different particle sizes from each other has superior in resistance to high pressure and superior in resistance to low temperature.

This application is based on Japanese Patent Application No. 2008-195159 filed on July 29. The disclosure of the above Japanese Patent Application is incorporated herein by reference in its entirety.

What is claimed is:

1. A rubber composition comprising:
a flexible rubber which includes a rubber component and softener, and at least two kinds of carbon blacks having different particle sizes from each other.

2. The rubber composition of claim 1, wherein the carbon blacks are a combination of ISAF (Intermediate Super Abrasion Furnace Black) grade carbon black and MAF (Medium Abrasion Furnace Black) grade carbon black.

3. The rubber composition of claim 1, wherein the rubber component is at least one rubber component selected from the group consisting of ethylene-propylene-diene rubber (EPDM), acrylonitrile-butadiene-rubber (NBR) and hydrogenated nitrile butadiene rubber (HNBR).

4. The rubber composition of claim 1, wherein the softener is at least one softener selected from the group consisting of paraffinic process oil, naphthenic process oil, aromatic process oil, white oil, petrolatum and gilsonite.

5. The rubber composition of claim 1, wherein the softener is at least one softener selected from the group consisting of phthalate ester plasticizer, adipate ester plasticizer, aliphatic diacid plasticizer, phosphate ester plasticizer, citrate ester plasticizer, trimellitate plasticizer, epoxidized vegetable oil, vegetable oil-derived softener, polyetherester and polybutene.

6. The rubber composition of claim 1, wherein the rubber component is ethylene propylene diene rubber (EPDM), the softener is paraffinic process oil and the flexible rubber is an oil-extended ethylene-propylene-diene rubber (EPDM).

7. The rubber composition of claim 1, wherein the rubber component is acrylonitrile butadiene rubber (NBR), the softener includes at least one of adipate ester plasticizer, vegetable oil-derived softener and polyetherester.

8. The rubber composition of claim 1, further comprising: a co-cross-linking agent.

9. The rubber composition of claim 1, the co-cross-linking agent is at least one co-cross-linking agent selected from the group consisting of ethylene glycol dimethacrylate(EDMA), trimethyl-propane trimethacrylate (TPTA), trimethylol propane trimethacrylate, triallyl cyanurate(TAC), triallyl iso cyanurate(TAIC), triallyl trimelitate(TAM) and tetraallyl terephthalamide.

10. The rubber composition of claim 1, wherein the co-cross-linking agent is added in an amount in the range of 1 to 10 pts.wt per 100 pts.wt of the rubber compositon.

11. The flexible rubber of claim 1, wherein the content of the softener per 100 pts.wt. of the rubber component is from 20 pts. wt. % to 70 pts. wt. %

12. The rubber composition of claim 1, wherein the at least two kinds of carbon blacks having different particle sizes from each other is added in an amount in the range of 70 pts.wt. to 150 pts.wt. per 100 pts. wt. of the flexible rubber.

13. A sealing member including a rubber composition comprising:
a flexible rubber which includes a rubber component and a softener, and at least two kinds of carbon blacks having different particle sizes from each other.
